(19) United States
(12) Patent Application Publication
(10) Pub. No.: US 2017/0342772 A1
(43) Pub. Date: Nov. 30, 2017

(54) VERTICALLY ORIENTATED LADDER APPARATUS FOR ALLOWING A CLIMBER TO ADOPT AN IMPROVED CLIMBING STANCE IN USE

(71) Applicant: Glenn RODDENBY, Lightning Ridge (AU)

(72) Inventor: Glenn RODDENBY, Lightning Ridge (AU)

(21) Appl. No.: 15/534,769

(22) PCT Filed: Nov. 27, 2015
(86) PCT No.: PCT/AU2015/050749

§ 371 Date: Jun. 9, 2017

(30) Foreign Application Priority Data
Dec. 15, 2014 (AU) 2014905077
Mar. 13, 2015 (AU) 2015900904

(51) Int. Cl. E06C 1/38; E06C 1/34; E06C 7/08; E06C 7/18

(52) U.S. Cl. CPC E06C 1/38; E06C 7/183; E06C 1/34; E06C 7/082

(57) ABSTRACT

A vertically orientated ladder apparatus allowing a climber to adopt an improved climbing stance wherein the climber's arms are poised economically in front of the climber within the climbing passage; the climber's legs are spread for the lateral stability of the climber so as to reduce the tendency of the climber falling sideways; and the climber is substantially upright such that the climber's centre of gravity lies substantially between the opposing steps (11) so as to allow the climber to release the climber's grip on the hand rails (14) while remaining balanced and supported by the legs of the climber. Opposing steps (11) are level or staggered. Embodiments include three or four stiles (12, 15).

### FIELD OF THE INVENTION

The present invention relates to ladders and in particular, but not necessarily entirely, to a vertically orientated ladder apparatus.

### BACKGROUND OF THE INVENTION

Ladder design has remained relatively unchanged for thousands of years despite severe limitations of conventional arrangements, especially those relating to safety.

Specifically, turning to FIG. 1, there is shown a conventional vertically orientated runged ladder arrangement. As can be seen from the exemplary figure, the climber is required to use the climber's legs and feet to climb vertically and the climber's arms and hands to hold laterally onto the ladder.

As can be appreciated, the climber's centre of gravity lies behind the ladder such that were the climber to lose grip of the rungs, the climber would fall from the ladder.

Furthermore, this conventional ladder arrangement requires the use of the climber's hands at all times, being problematic in inducing climber fatigue.

Furthermore, with conventional ladder arrangements, the climber is unable to carry goods with one or both hands without having to let go of the rungs.

The above-mentioned problems may be mitigated to a certain extent through the inclination of the ladder, such as a substantially shown in FIG. 2 where in the prior art runged ladder 1 is lent against an immovable object 2.

Similarly, FIG. 3 shows the conventional step ladder arrangement 3 comprising the inclined ladder. Now, and considering specifically FIG. 2, in this inclined configuration the climber's reliance on the climber's hands is reduced somewhat, but not entirely. Specifically, in the inclined ladder arrangement the climber may let go momentarily but not for long. In doing so, as the climber's centre of gravity is substantially above the climber's lower limbs, the climber will not fall as readily from the ladder as would the climber for from the vertical ladder as a substantially provided in FIG. 1 but after a short time the climber would become unbalanced and probably toppled backwards.

It should be noted that inclined ladders are ill suited for vertical application, such as, for example, within vertical shafts for mining, ascending vertical faces of buildings, ascending telegraph poles and the like.

As such, so as to attempt to provide vertical application with increased safety, the squirrel cage vertical ladder arrangement 4 as substantially shown in FIG. 4 has been developed. As can be seen, the arrangement 4 comprises the conventional vertical runged ladder arrangement surrounded by a squirrel cage supposedly adapted to arrest a climber's fall should the climber fall from the runged ladder.

However, experience has shown that the squirrel cage arrangement is not necessarily safety conferring and may itself injure the falling user. Indeed, studies have shown that the squirrel cage may provide a false sense of security inducing climbers take greater risks.

Further attempts have been made to address the above and other problems of conventional ladder arrangements.

Specifically, turning now to FIG. 5, there is shown a vertical ladder arrangement 5 in accordance with the prior art as it is published and laid open patent WO 2013/105880 A2 (BABAYLOVA), hereinafter referred to as D1 for convenience.

According to the abstract of D1, the vertical ladder 5 is intended for use in confined spaces.

The ladder 5 comprises: a frame made up of vertical posts and of cross pieces which interconnect adjacent vertical posts; steps, each of which is moveably fastened to the frame such as to be able to rotate about a horizontal axis; and means for securing the steps in a horizontal position.

As can be seen, the vertical ladder arrangement 5 comprises pivotable steps that may be pivoted upwards when not in use and pivoted downwards when required for stepping on as the climber climb the ladder so as to allow the ladder to occupy less space within confined spaces.

FIG. 6 shows a top view of the ladder 5 of D1 wherein, as can be seen, step 6 is laid out horizontally for stepping and step 7 has been pivoted upwardly for stowage.

The English translation of D1 specifies that “To raise the ladder a person must turn starting from the bottom up, transfer from a vertical position to a horizontal position of the two vertical rows of steps 8, 9, each time stepping up to the next level. Steps supported from below, ie. E. Stage fixed in a horizontal position by a horizontal crossbar 4 of which are perpendicular to the axes of rotation of stages r. E. Lie in the plane of FIG. 1. Continuing in this way translate into a horizontal position the upper stage, a man rises to the top of the stairs. To descend the stairs a man must turn, counting from the top down, transfer from a horizontal position to a vertical position stage two vertical rows 8, 9, each time stepping down to the next level. Continuing in this way translate into a vertical position downstream stage, people down to the ground on which the ladder or staircase over which hangs if the staircase, for example, is attached to the walls of the room.”

However, D1 suffers from several problems.

Firstly, D1 is unable to allow the climber to adopt the improved climbing stance as will be described in further detail hereinbelow.

D1 suffers from a further problem in ascending the ladder 5 in that once having moved up a rung and therefore require a new foothold, the climber is required to utilise the climber's foot to find the next vertically orientated step, engage the edge of the step and push the step downwards so as to pivot the step outwardly so as to be able to stand on the step. As can be appreciated, in the confined space the climber may not necessarily have a clear view of the climber's feet potentially resulting in the fumbling of the feet while attempting to lay out the steps for standing posing in itself a significant safety risk.

D1 suffers from a further problem in descending the ladder in that once having ascended the ladder in the manner described above, all of the steps would have been horizontally orientated. However, to descend the ladder the climber is required to move the steps out of the way. In this manner, the climber is required to therefore undertake a more difficult manoeuvre in stowing the steps involving the process of placing once foot underneath the inner edge of the horizontally laid step so as to bring it upwards all while balancing on the opposing step.

As such, when ascending and descending the ladder and physically lowering or raising the steps in this manner, the climber cannot let go of the rungs of D1. Conversely, as will be shown in the ensuing detailed description, the ladder provided in accordance with the present embodiments reduces the climber's reliance on the climber's hands, including allowing the climber to ascend and descend the ladder without using the climber's hands at all.

Indeed, the requirement to manipulate the steps as per D1 actually increases the climber's reliance on the climber's hands componding problems including in that the climber is therefore not able to carry goods with free hands.

Furthermore, the requirement to manipulate the steps in this manner slows the ascent or descent of the climber being especially dangerous in emergency situations where a climber may need to ascend or descend the ladder quickly.

Furthermore, when ascending the ladder, the climber is obstructed by the horizontally projecting steps above being required to push them out of the way. As alluded to above, it is a requirement of D1 that the steps are pivotable such that the ladder 1 occupies less space so as to be applicable for confined spaces. As will be appreciated from the ensuing description, the ladder of the present embodiments has is not necessarily been developed for utilisation within confined spaces, but for allowing the climate to adopt the above-mentioned improved climbing stance.

Furthermore, imagine a scenario where a climber descends a vertical structure from a great height such as from a wind turbine tower using the ladder of D1 and raises all of the steps on the way down. For the next person to descend the ladder, all of the steps will be raised thereby creating a significant safety risk in that the subsequent climber, especially the absent-minded subsequent climber, may fall to his death on account of there being no steps available for stepping on.

As such, while D1 may be suited for confined spaces, being the stated purpose of D1, D1 is ill suited for other applications including for reasons of introducing the above problems.

Turning now to FIGS. 7, 8 and 9, there are provided further embodiments of prior art ladder arrangements.

Now, FIG. 7 shows an embodiment published in laid open patent specification U.S. Pat. No. 4,199,040 A (LAPEYRE), hereinafter referred to as D2. According to the abstract, D2 provides ladder which is especially adapted for shipboard use and which is safe and comfortable to use, of relatively light weight and occupying relatively small floor and overhead space. The ladder comprises a single stringer disposed between upper and lower deck or floor levels at a predetermined angle of inclination, and having an array of half treads on each side of the stringer, each array being vertically spaced from the other along the length of the stringer. The half treads are affixed to and extend from the respective sides of the stringer and each include an integral outwardly extending portion which terminates in a plane forward of a plane passing through the front edges of the treads. Rungs are disposed in this forward plane and are affixed to and supported by the outwardly extending tread portions.

FIG. 8 shows an embodiment published in laid open patent specification U.S. Pat. No. 4,535,871 A (LAPEYRE) hereinafter referred to as D3.

According to the abstract, D3 provides a stair or ladder which has a central stringer adapted for mounting between an upper level and a lower level at a relatively steep angle of inclination, and a plurality of tread members disposed in alternating arrangement on respective sides of the stringer, each of the tread members having a foot support portion outwardly extending from the stringer. A pair of rungs is disposed substantially in a plane forward and parallel to a plane passing through the front edges of the foot support portions and positioned with respect to the foot support portions to provide support of the user. The tread members are substantially identical, except for the top tread and bottom tread of the stairway and include a foot support portion and an outwardly extending support adapted for connection to a rail. The stairway is preferably composed of components preformed of aluminum and welded together to provide a completed structure which is relatively light weight, rigid, and strong.

Furthermore, FIG. 9 shows an embodiment published in laid open patent specification U.S. Pat. No. 4,509,617 A (LAPEYRE) referred to hereafter as D4.

According to the abstract D4 provides a stair having a central stringer and two parallel side stringers. A plurality of vertically-spaced half treads is disposed on each side of the central stringer and extends between the central stringer and an adjacent side stringer. The half treads on one side of the central stringer alternate with those on the other side of the central stringer. The central stringer may or may not be a structural member depending upon the stair configuration but in all cases serves at least as a protective shielding of the inside corners of the treads, thereby minimizing climber injury from the corners in case of a fall or other climber mishap. A pair of rungs are disposed in a plane forward and parallel to a plane passing through the front edges of the treads and positioned with respect to the treads to provide support for a user.

However, all of the embodiments provided by publications D2-D4 are inclined ladders and are therefore prone to the disadvantages mentioned above.

The present invention seeks to provide a vertically orientated ladder apparatus, which will overcome or substantially ameliorate at least some of the deficiencies of the prior art, or to at least provide an alternative.

It is to be understood that, if any prior art information is referred to herein, such reference does not constitute an admission that the information forms part of the common general knowledge in the art, in Australia or any other country.

### SUMMARY OF THE DISCLOSURE

According to one aspect, there is provided a vertically orientated ladder apparatus comprising a pair of laterally positioned and vertically orientated stiles; opposing horizontal steps immovably fixed to respective inner faces of the lateral stiles for stepping on by a climber in use; and horizontal hand rungs extending between the stiles for gripping by the climber in use; wherein the apparatus is configured for allowing a climber to adopt an improved climbing stance in use in that: the steps project inwardly such that each step is laterally useable for stepping on and off by the climber using lateral step movements of each respective foot of the climber as the climber climbs the ladder; the steps are spaced apart laterally so as to define a vertical climbing passage therebetween, the climbing passage being sufficiently wide to as to fit at least the shoulders of the climber between the opposing steps to allow a climber to climb within the vertical climbing passage without obstruction by the steps; the hand rungs are located at an appropriate distance in front of the climber so as to allow sufficient room in front of the climber for the movement of the climber's arms within the lateral extent of the climbing passage as the climber climbs the passage, such that, in the improved climbing stance: the climber's arms are poised ergonomically in front of the climber within the climbing passage within the room allowed for by the forwardly located hand rungs so as to negate the need for the climber to lean backwards or forwards to grip the hand rungs and wherein the climber is able to reach the hand rungs in front with bent arms while being able to reach the next upper or lower hand rungs with straighter arms; the climber's legs are spread for the lateral stability of the climber so as to reduce the tendency of the climber falling sideways; and the climber is substantially upright such that the climber's centre of gravity lies substantially between the opposing steps so as to allow the climber to release the climber's grip on the hand rails while remaining balanced and supported by the legs of the climber.

Each step may comprise an outer located vertical end flange to limit the lateral movement of each respective foot in use.

Each hand rung connects a pair of opposing steps.

Each hand rung transitions through substantially 180° so as to provide a portion of the hand rung located at the appropriate distance in front of the climber.

Each hand rungs may be substantially U-shaped.

The opposing horizontal steps may be alternately vertically staggered.

The apparatus may further comprise at least one central stile.

Each hand rung may be fastened to a respective step and the stile.

The hand rungs may each transition through substantially 90° so as to be able to fasten to the respective step and the stile.

Each hand rung may be substantially L-shaped.

The at least one central stile may comprise two central stiles.

Each hand rung may be fastened to a respective step and both of the central stiles.

At least one distal end of each of the pair of laterally positioned stiles may comprise connectors for connecting to an adjacent pair of stiles.

The connectors may be fastened to respective surfaces of the respective adjacent stiles so as to allow the adjacent styles to abut directly and in line with each other so as to maintain the weight-bearing capabilities of the adjacent stiles.

Central portions of a subset of the hand rungs may be been removed so as to define a climber gate.

The ladder apparatus may be configured in a forward facing configurations such that the climber faces a building structure, the gate may be located at an upper location of the ladder apparatus so as to allow the climber to step onto a raised platform of the building structure through the gate.

When the ladder apparatus is configured in a rearward facing configurations such that the climber faces away from a building structure, the gated may be located at a ground level of the ladder apparatus so as to allow the climber to step into the climbing passage.

Other aspects of the invention are also disclosed.

### BRIEF DESCRIPTION OF THE DRAWINGS

Notwithstanding any other forms which may fall within the scope of the present invention, a preferred embodiments of the disclosure will now be described, by way of example only, with reference to the accompanying drawings in which:

FIGS. 1-9 show ladders in accordance with the prior art;

FIGS. 10-15 show a vertically orientated ladder apparatus in accordance with a preferred embodiment of the present disclosure;

FIGS. 16-19 show an improved climbing stance of a climber climbing the vertically orientated ladder apparatus of FIGS. 10-15;

FIG. 20 shows a further simpler embodiment of a vertically orientated ladder apparatus in accordance with an embodiment of the present disclosure;

FIG. 22 shows an embodiment of the vertically orientated ladder comprising a single central stile in accordance with an embodiment of the present disclosure;

FIG. 23 shows an embodiment of the vertically orientated ladder comprising a reinforcing double central stiles in accordance with an embodiment of the present disclosure;

FIG. 24 shows connection details for connecting adjacent ladder sections in accordance with an embodiment of the present disclosure; and

FIG. 25-26 show top and bottom entry and exit gates for the vertically orientated ladder in accordance with embodiments of the present disclosure.

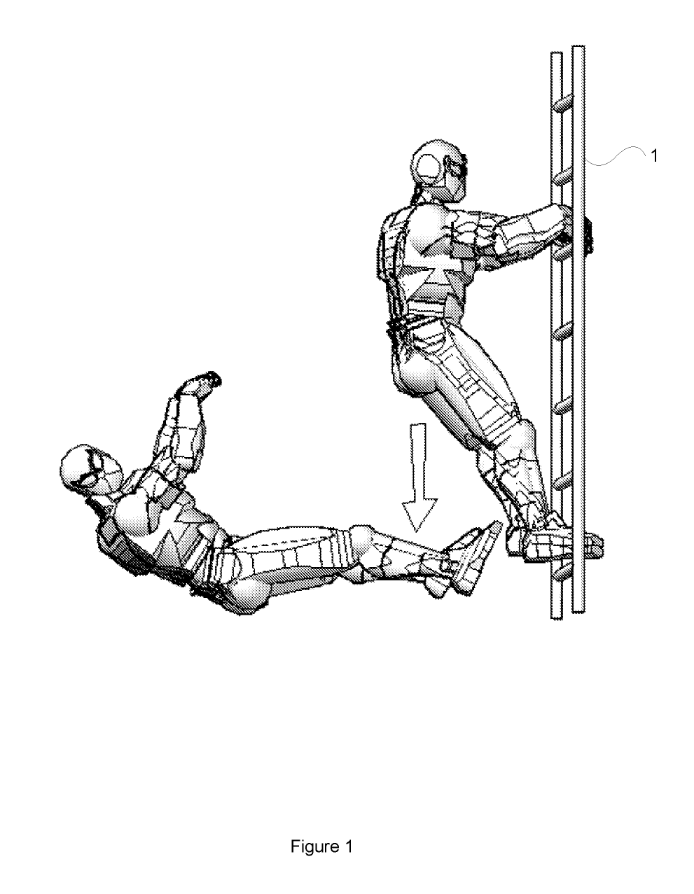

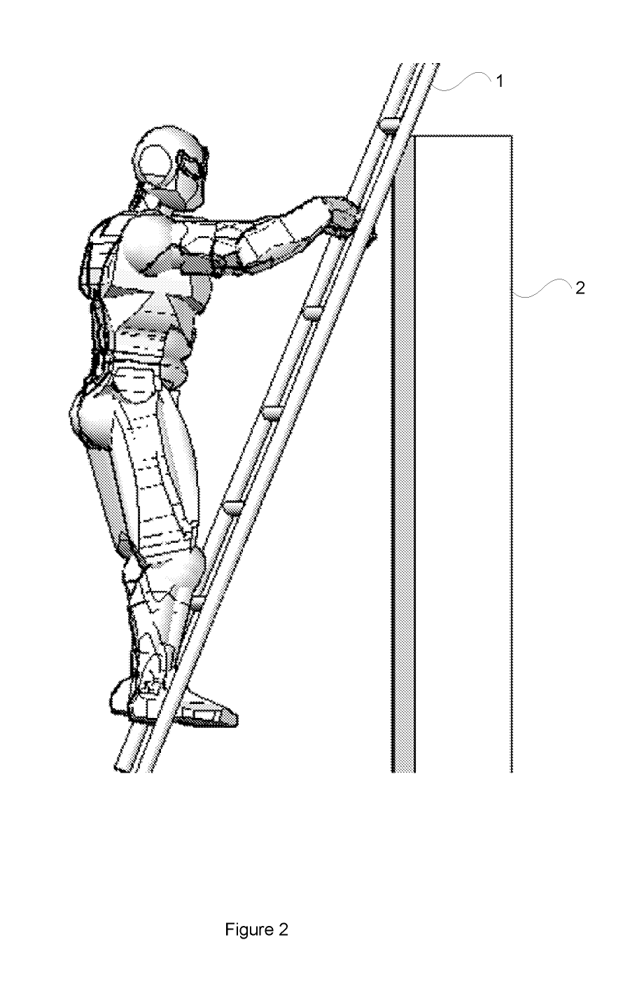

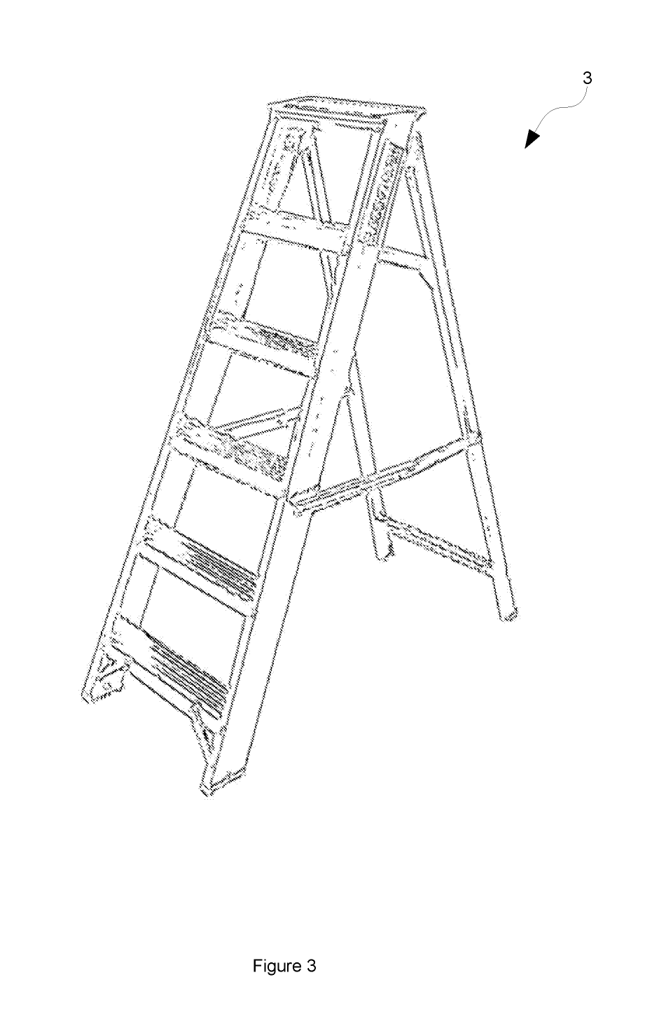

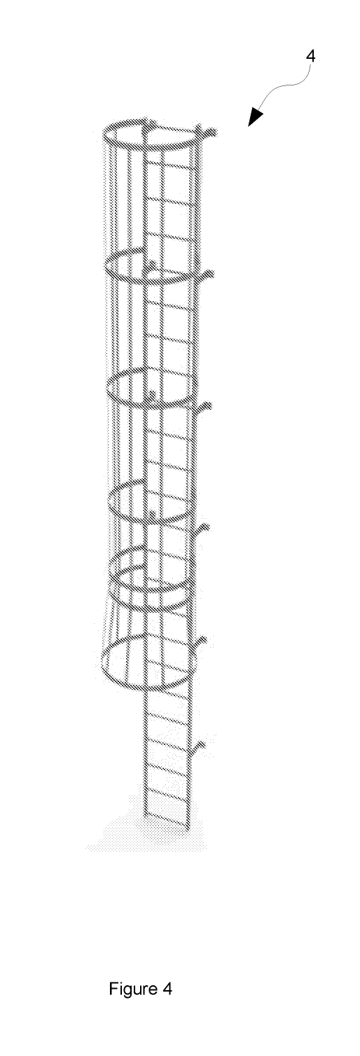

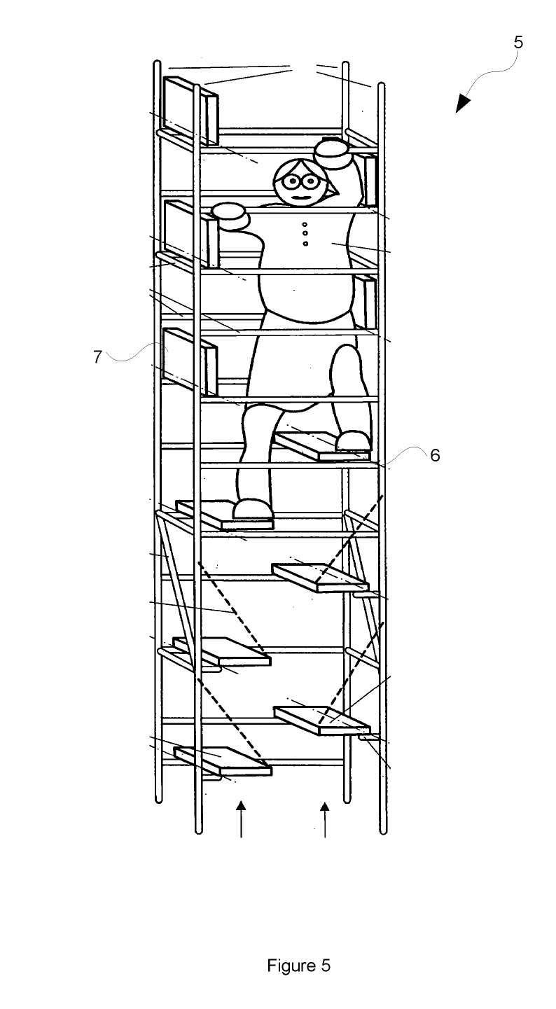

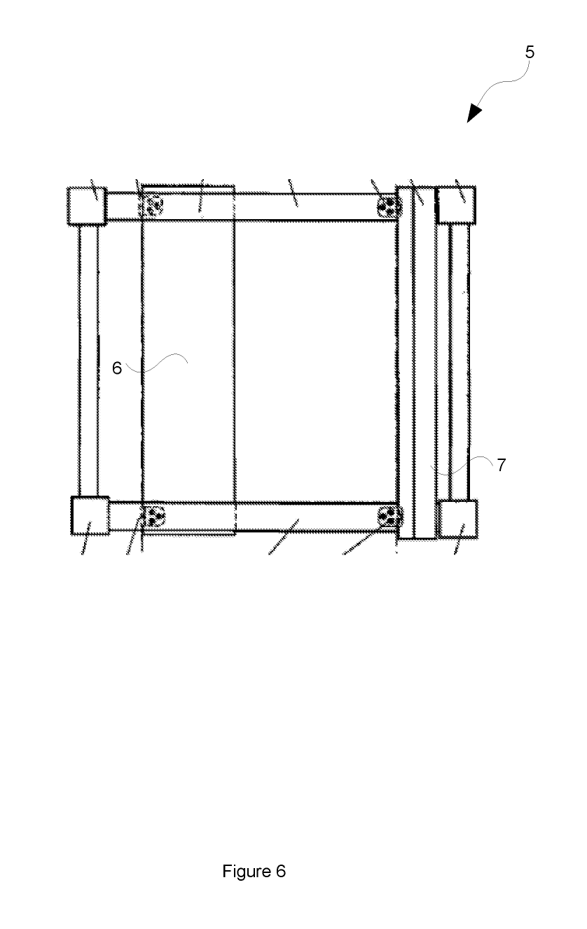

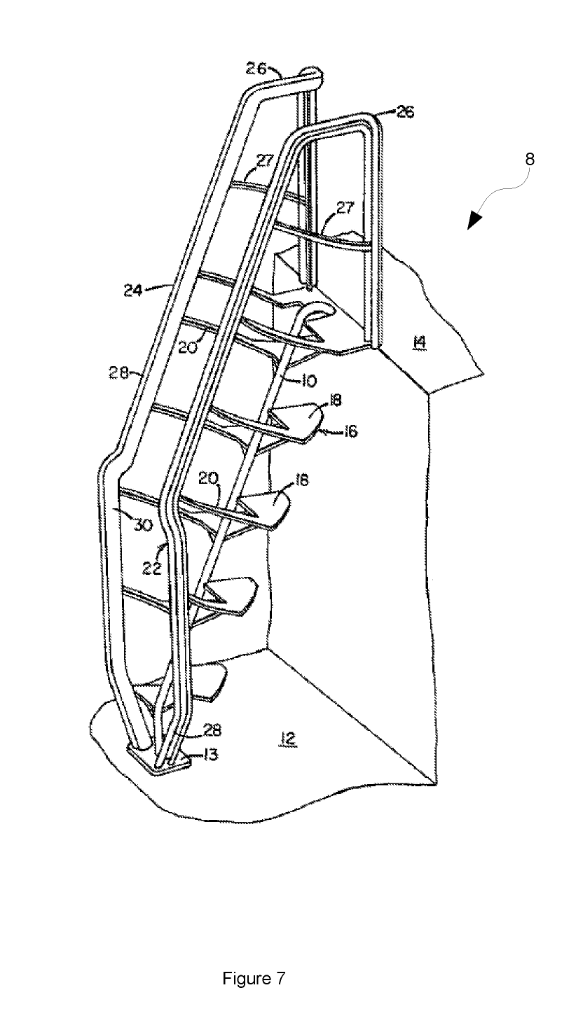

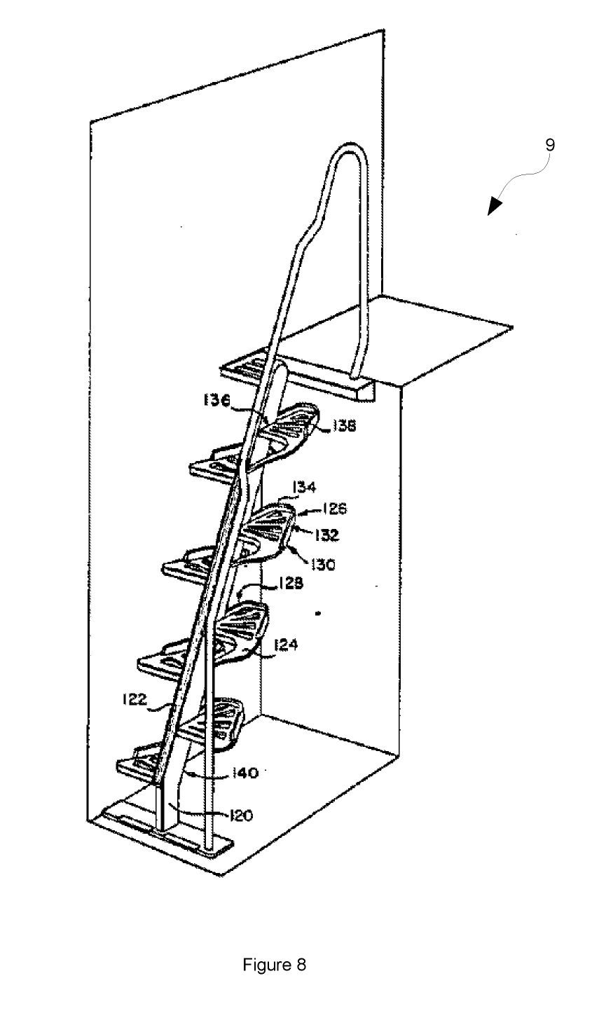

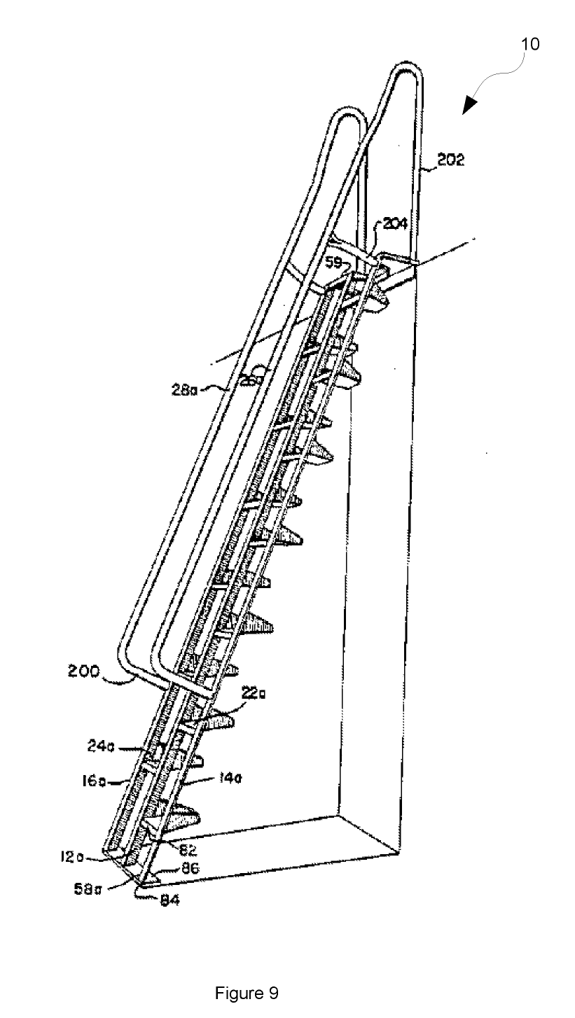

### DESCRIPTION OF EMBODIMENTS

For the purposes of promoting an understanding of the principles in accordance with the disclosure, reference will now be made to the embodiments illustrated in the drawings and specific language will be used to describe the same. It will nevertheless be understood that no limitation of the scope of the disclosure is thereby intended. Any alterations and further modifications of the inventive features illustrated herein, and any additional applications of the principles of the disclosure as illustrated herein, which would normally occur to one skilled in the relevant art and having possession of this disclosure, are to be considered within the scope of the disclosure.

Before the structures, systems and associated methods relating to the vertically orientated ladder apparatus are disclosed and described, it is to be understood that this disclosure is not limited to the particular configurations, process steps, and materials disclosed herein as such may vary somewhat. It is also to be understood that the terminology employed herein is used for the purpose of describing particular embodiments only and is not intended to be limiting since the scope of the disclosure will be limited only by the claims and equivalents thereof.

In describing and claiming the subject matter of the disclosure, the following terminology will be used in accordance with the definitions set out below.

It must be noted that, as used in this specification and the appended claims, the singular forms “a,” “an,” and “the” include plural referents unless the context clearly dictates otherwise.

As used herein, the terms “comprising,” “including,” “containing,” “characterised by,” and grammatical equivalents thereof are inclusive or open-ended terms that do not exclude additional, unrecited elements or method steps.

It should be noted in the following description that like or the same reference numerals in different embodiments denote the same or similar features.

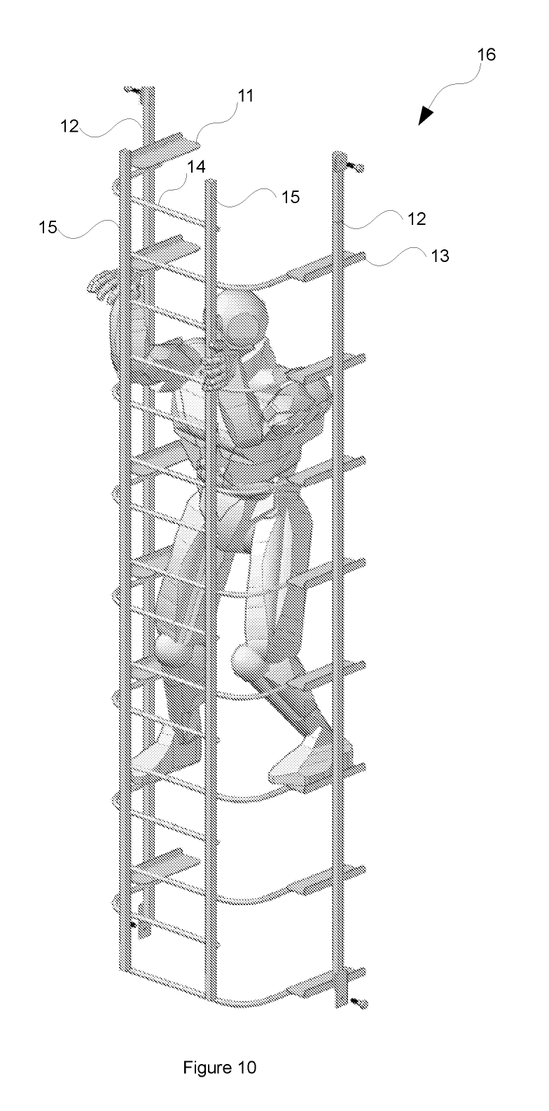

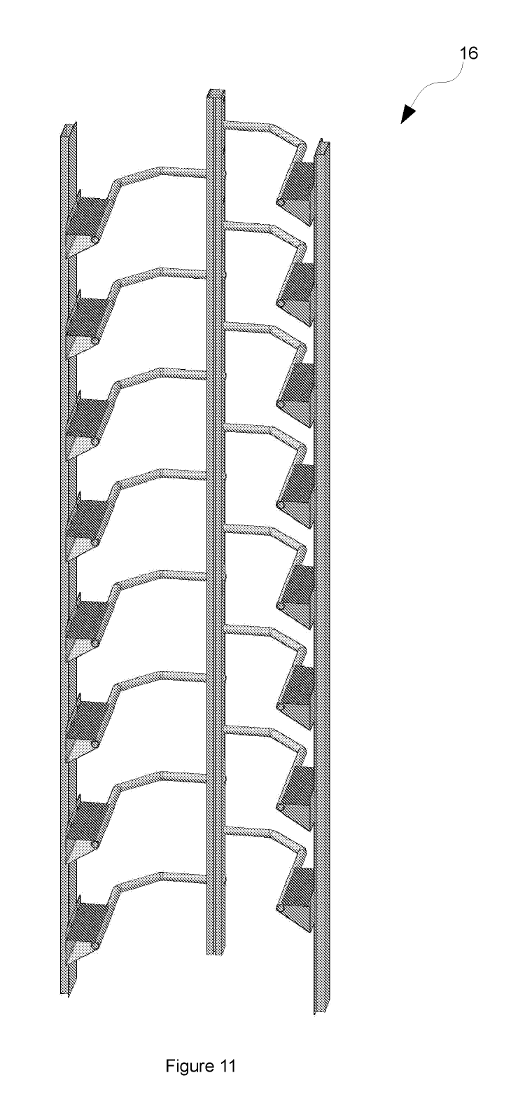

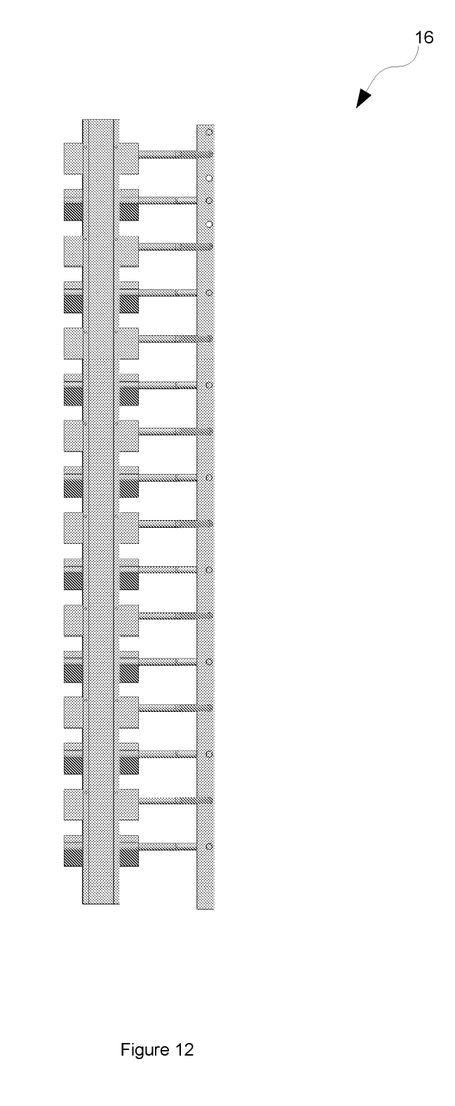

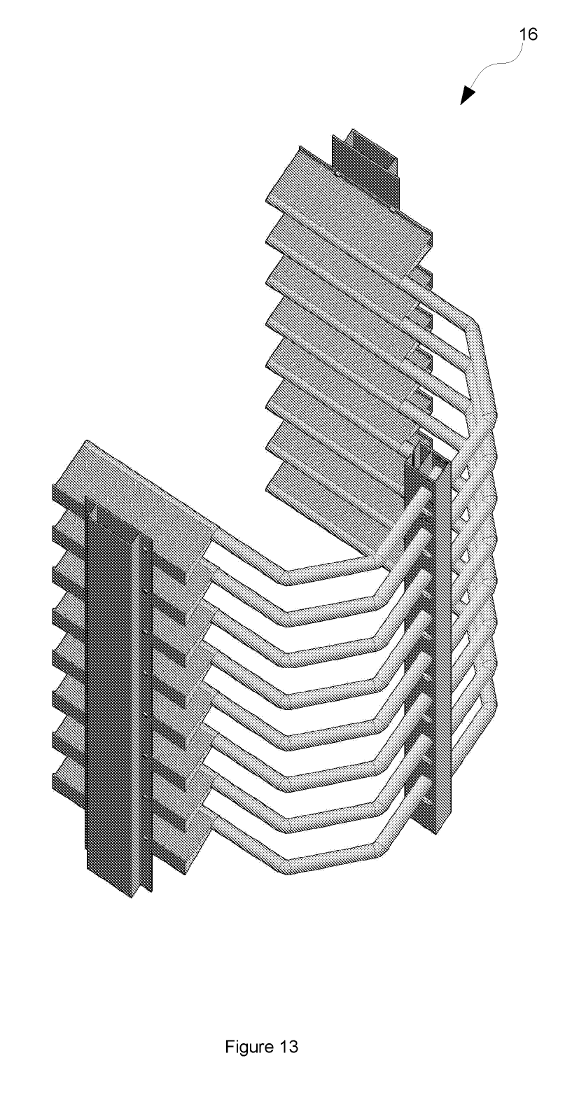

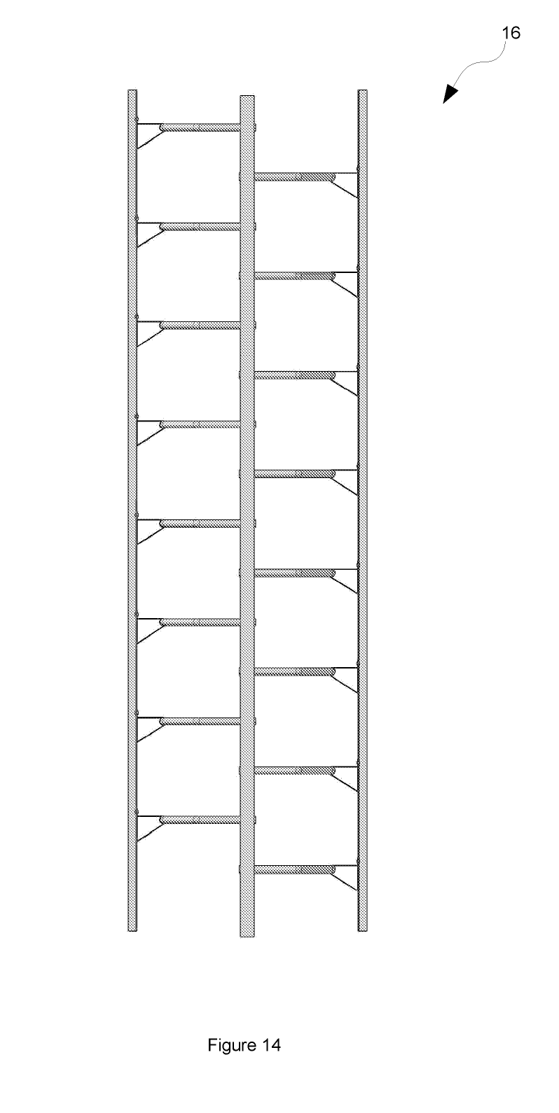

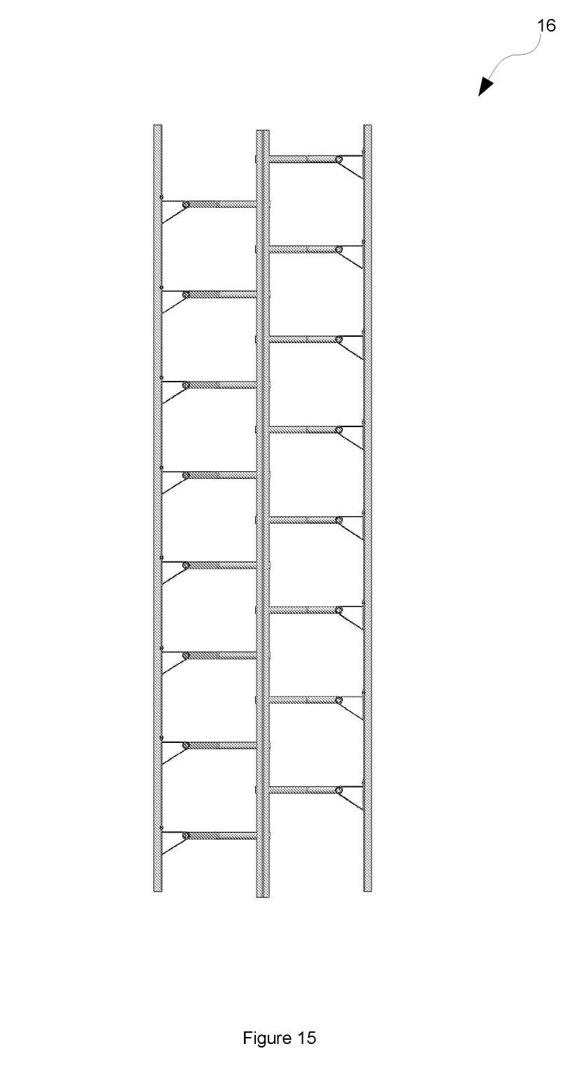

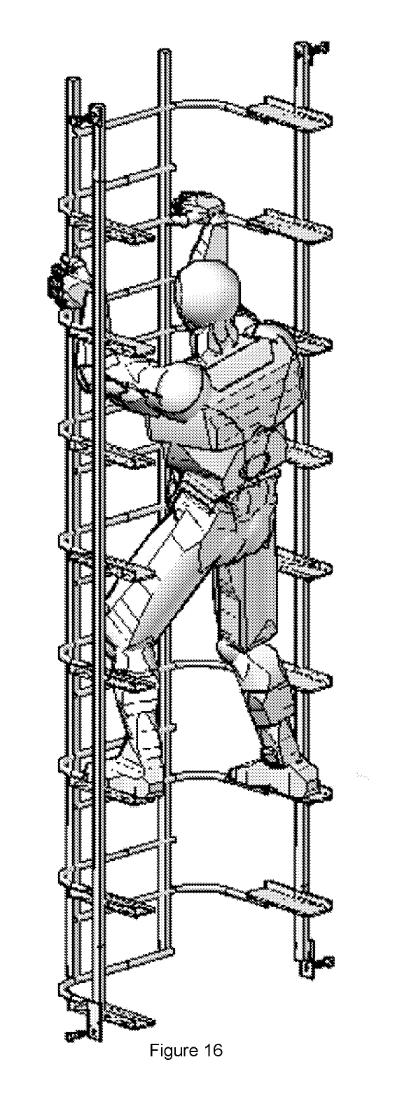

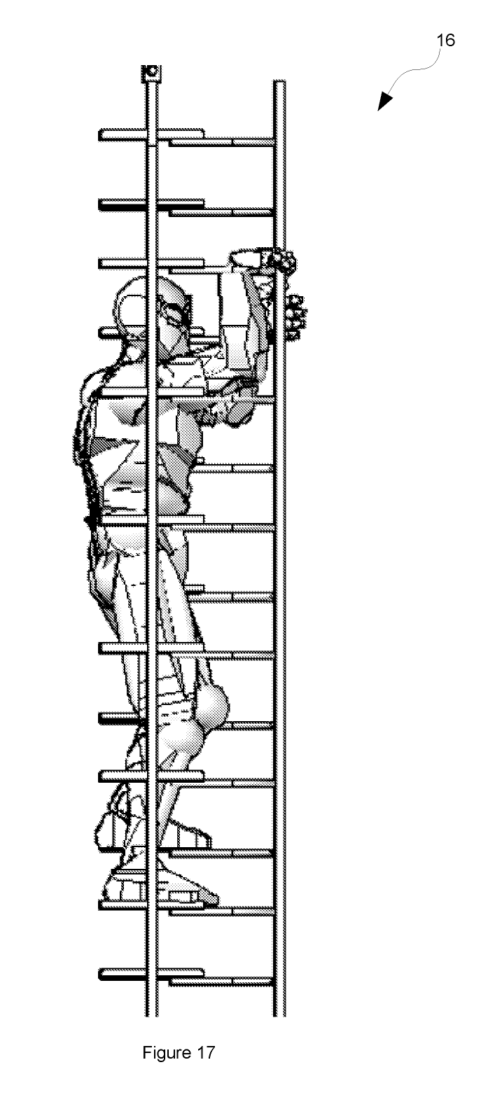

Turning now to FIG. 10, there is shown a vertically orientated ladder 16 in accordance with a preferred embodiment of the present disclosure. As will become apparent from the ensuing description, the ladder 16 eliminates or at least substantially ameliorates problems of conventional arrangements, including those described above relating to safety, climber fatigue, usability and the like.

Specifically, as will be described in further detail below, the ladder 16 is configured for allowing the climber to adopt an improved climbing stance conferring the above advantages in safety and usability.

As is shown in FIG. 10, the ladder apparatus 16 comprises a pair of laterally positioned and vertically orientated stiles 12.

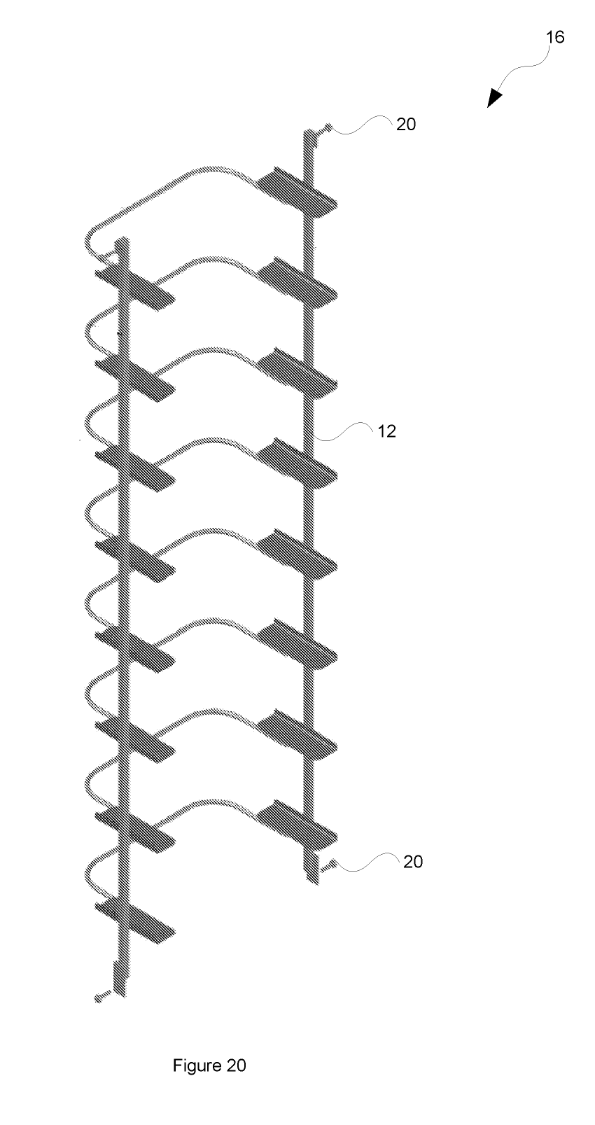

The ladder 16 further comprises opposing horizontal steps 11 immovably fixed to respective inner faces of the lateral stiles 12. Turning to FIG. 19, as can be seen, the horizontal steps 11 project inwardly such that each step is laterally useable for stepping on and off by the climber using lateral step movements of each respective foot of the climber as the climber climbs the ladder. Considering again the FIG. 10, in embodiments, the horizontal steps 11 may comprise an edge flange 13 to limit the lateral movement of the foot of the climber in use.

Furthermore, the ladder 16 comprises hand rungs 14 extending between the stiles 12.

### Improved Climbing Stance

Now, as alluded to above, the configuration as substantially shown in FIG. 10 allows the climber to adopt an improved climbing stance when compared to conventional ladder arrangements.

As can be seen, the steps are spaced apart laterally so as to define a vertical climbing passage therebetween.

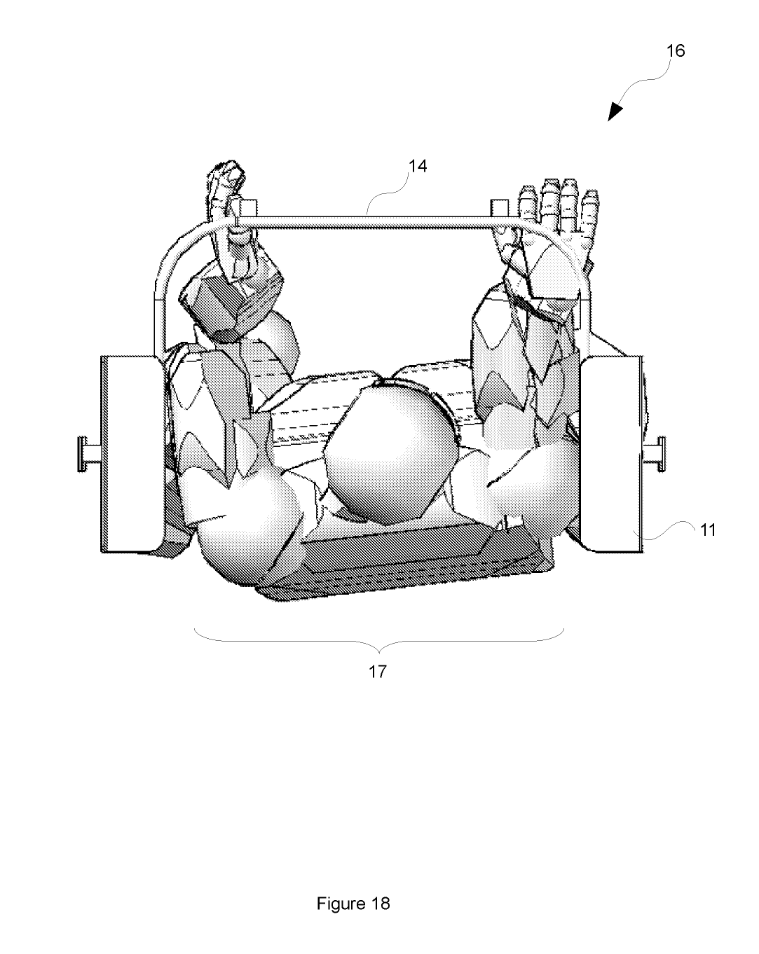

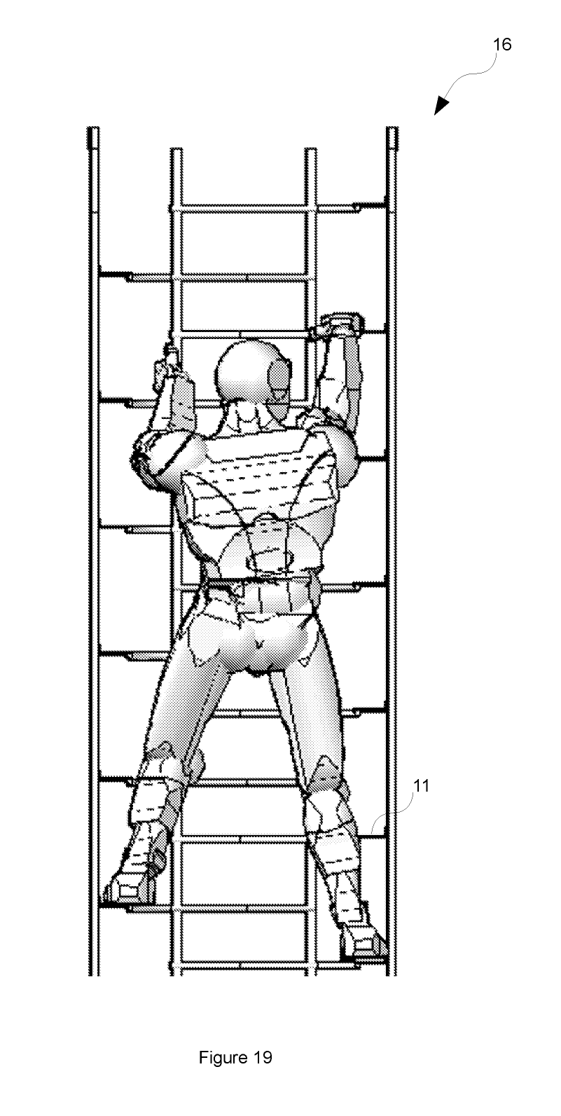

Specifically, turning to FIG. 18, there is shown a top view of the ladder apparatus 16 in use. As can be seen, the climbing passage 17 is sufficiently wide so as to fit at least the shoulders of the climber between the opposing steps. As can also be seen from FIG. 18, the arms of the climber extend forwards between the horizontal steps 11. In this manner, and as will be discussed in further detail below, the hand rungs 14 allocated suitably forward of the climber in use so as to allow the ergonomic gripping and use thereof. Specifically, the ergonomic use thereof comprises at least one of 1) the provision of sufficient space to allow the climber to move the climber's arms within the lateral edges of the climbing passage between the horizontal steps 11 and 2) the climber being able to grip the rungs most proximate with the shoulders of the climber with comfortably bent arms and to be able to reach and subsequently grip adjacent upper and lower hand rungs 14 with straight arms.

Similarly, turning now to FIG. 19, there is shown a rear elevation view of the ladder 16 in use showing the spacing apart of the opposing steps 11 so as to allow a sufficiently wide climbing passage to fit at least the shoulders of the climber.

As can be seen, the hand rungs 14 are located sufficiently forwards so as to allow for the ergonomic gripping thereof. Specifically, as can be seen, the user's arms are forwardly orientated so as to fit between the horizontal steps 11 and naturally bent so as to easily grip the hand rungs 14 in front of the climber and allow the climber to reach the next adjacent above and below hand rungs with straighter arms.

Specifically, the extent of the forward location of the rungs 11 lies between the full extent of the length of the climber's arms and the shoulders of the climber so as to allow the climber to reach the hand rungs 14 substantially coinciding with the shoulders of the climber with bent arms and so as to allow the reaching of the upper and lower rungs 11 with straight arms.

Now, and referring again to FIG. 10, the above-described configuration of the ladder 16 allows the climber to adopt the improved climbing stance as a substantially provided in FIG. 10.

As can be seen, the climber's torso is substantially vertically orientated with the vertical axis of the ladder. In other words, the torso of the climber is orientated as if the climber was standing naturally.

By positioning the torso of the climber substantially vertically, the ladder 16 advantageously reduces the climber's reliance on the climber's hands for holding onto the ladder 16. Specifically, as can be appreciated, and in making reference to FIG. 1 showing the conventional vertical ladder arrangement the torso of the climber is inclined away from the ladder placing strain on the arms of the climber. As such, with the prior art arrangement of FIG. 1, should the climber let go of the rungs, even momentarily, the climber would topple backwards on account of the inclined torso angle and immediately fall from the ladder 1.

However, in considering again FIG. 10, by positioning the torso of the climber substantially vertically, reliance on gripping the hand rungs 14 is reduced or eliminated entirely. Specifically, as can be appreciated from FIG. 10, the climber is able to let go of the rungs and even climb the ladder 16 without holding onto the rungs.

In this manner, the ladder 16 provides advantages in safety in that were the climber to let go of the hand rungs 14 the climber would not fall from the ladder 16. Furthermore, the ladder 16 allows the climber to carry items with hands freed from not being necessarily required to hold onto the rails 14.

Furthermore, in the improved climbing stance, the climber's arms are able to selectively grip the hand rungs in an ergonomic manner. Specifically, as alluded to above, the hand rungs are positioned sufficiently forwards so as to allow the climber to grip the hand rungs 14 most proximate with the shoulders of the climber with bent arms in a comfortable and ergonomic manner and so as to be able to straighten the climber's arms to reach the next upper and lower hand rungs 14.

As can be appreciated, with conventional vertical ladder arrangements such as that which is shown in FIG. 1, were the climber to attempt to position the climber's torso vertically, the climber would be required to bring the climber's arms right in such that the rungs lie substantially against the climber shoulders which is a non-ergonomic.

Furthermore, as can be seen, the spacing apart of the opposing steps 11 spreads the legs of the climber. As such, in the improved climbing stance, the climber has spread apart legs for lateral stability. Again, with conventional vertical ladder arrangements such as that which is provided in FIG. 1, the ladders 1 are typically narrow requiring the climber's feet to be placed substantially adjacent each other. In this manner, climbers often fall sideways from ladders by leaning too far to one side, such as when reaching for objects or when taking steps up the ladder. In this regard, should be noted that the ladder 16 yet allows the climber to reach across from the ladder 16 wherein the climber can insert the climber's arms between the hand rungs 14 while still remaining stable with the spaced apart foot stance.

Furthermore, in the improved climber stance, the climber's centre of gravity lies substantially between the opposing steps 11 so as to prevent falling should the climber let go of the hand rungs 14. Specifically, turning to FIG. 17, there is shown a side elevation view of the ladder 16 in use. As can be seen, the centre of gravity of the climber lies substantially between the steps 11. In this manner, the climber can let go of the hand rungs 11 and yet remain balanced on the steps.

Such a stance should be compared to the embodiment shown in FIG. 1 of the conventional vertical runged ladder arrangement wherein, as can be seen, the climber's centre of gravity lies behind the rungs of the ladder.

### Various Embodiments

It should be noted that the ladder 16 may take on differing shapes and configurations within the purposive scope of the embodiments described herein.

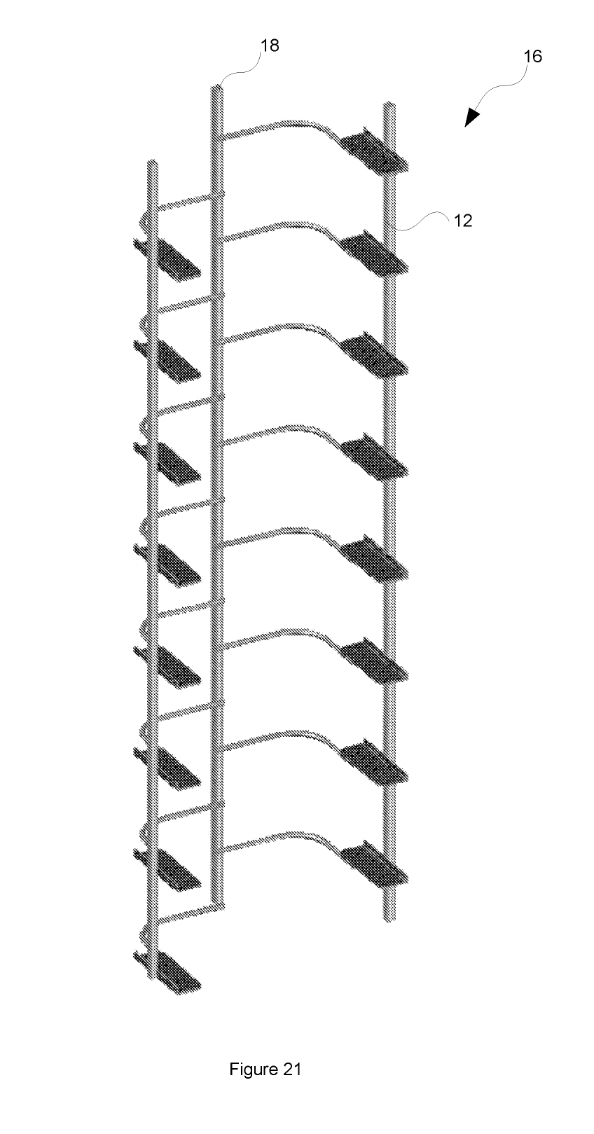

Specifically, turning to FIG. 20, there is shown a first embodiment of the ladder 16. As can be seen, the ladder 16 comprises relatively few components and material so as to provide a lightweight ladder structure. Specifically, in this embodiment shown in FIG. 20, the hand rungs 14 extend between vertically opposite steps 11 comprising the substantial U-shaped horizontal cross-section as is shown in the figure so as to locate the rails 14 sufficiently forward so as to allow the economic use thereof by the climber.

FIG. 21 shows a further embodiment of the ladder 16 wherein, as is immediately apparent, the steps 11 are alternately vertically staggered. Such staggering advantageously allows for the halving of the number of steps 11 required as compared to the embodiment is provided in FIG. 20.

As is also apparent from the embodiment in FIG. 21, the ladder 16 comprises a forwardly located central stile 18 to which the corresponding alternating rails 14 from the corresponding steps 11 are fastened. As such, in this embodiment, each rail 14 comprises a substantial L shape in the horizontal plane so as to traverse through the 90° orientation to connect to the central stile 18 and the sidesteps 11.

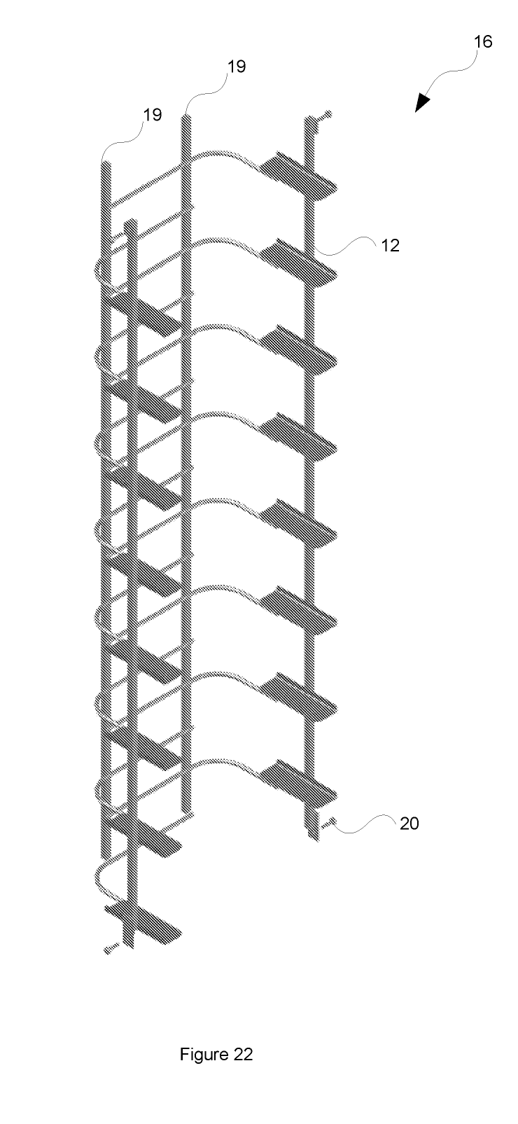

FIG. 22 shows a yet further embodiment of the ladder 16 wherein, as can be seen, the ladder 16 similarly comprises the alternating steps 11 but not necessarily so. One distinguishing aspect of the ladder 16 of FIG. 22 is that the ladder 16 comprises a pair of central forwardly located stiles 19.

The pair of centrally forward located stiles 19 reinforces the ladder 16 further increasing the rigidity thereof and the weight-bearing capabilities of the ladder 16. Furthermore, the centrally forward located stiles 19 allow the fasting of the ladder 16 to a building structure by the stiles 19.

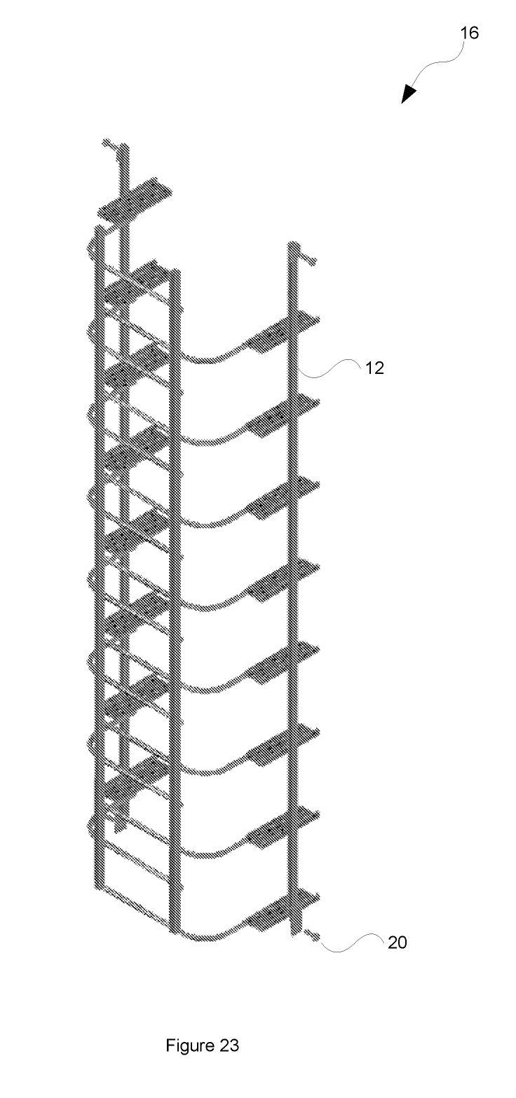

FIG. 23 shows an alternative perspective view of the ladder in accordance with the embodiment of FIG. 22.

### Connection to Adjacent Ladder Sections

As can be seen from the embodiments presented present in at least FIGS. 20, 22 and 23, the ends of the stiles 12 comprise fasteners for fastening to adjacent sections of ladder 16. In this manner, the ladder 16 may be manufactured in sections so as to allow the construction of a ladder assembly 16 utilising adjoining ladder sections 16 so as to reach differing desired heights.

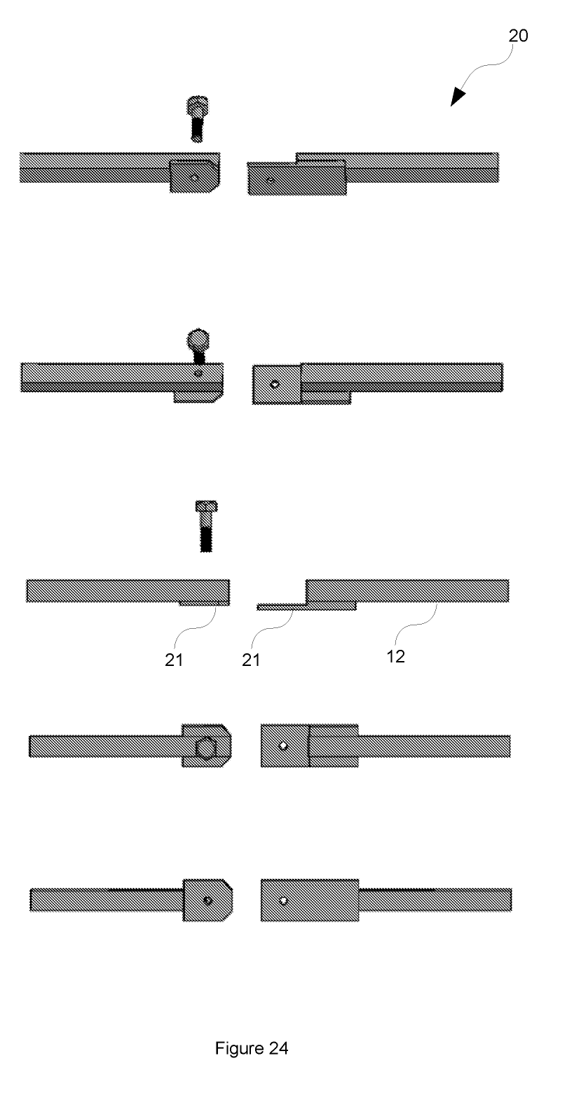

Specifically, FIG. 24 shows various views of an exemplary mechanical connection located at the respective distal ends of the stiles 12 for fastening to adjacent ladder sections. As can be appreciated, the fasteners comprise offset fish plates 21 so as to allow the ends of the stile 12 to abut against each other so as to allow for the transfer of weight through the ends of the stiles 12 so as to not hinder the weight-bearing capabilities of the ladder 16 when fastened in this manner.

### Upper End Gate

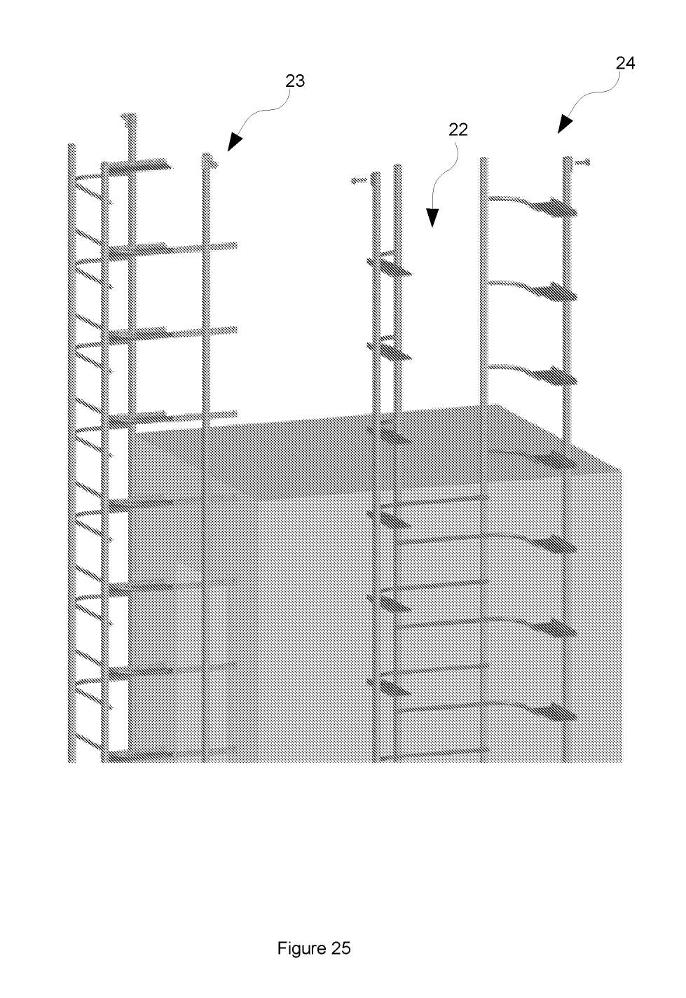

Turning now to FIG. 25, there is shown an embodiment of the ladder 16 wherein the ladder 16 has been configured so as to allow the transitioning of the climber from the ladder to a raised platform.

Specifically, as can be seen in the figure, the ladder 16 may be arranged in a forward facing configuration 24 such that, when climbing the ladder 16, the climber faces the building.

However, when reaching the raised platform, so as to negate the need for the climber to climb around the lateral stiles 12, or to be deprived of hand rungs above the upper surface of the platform, as can be seen in the embodiment shown, the central portions of the hand rails 14 have been removed so as to define an upper end gate 22 to allow the climber to step forwards through the ladder 16 to step onto the platform.

As is also shown the ladder 16 may be arranged in the rearward facing configuration 23 wherein the climber faces away from the building. As such, when reaching the elevated platform the climber need only turn around so as to step onto the platform.

### Bottom End Gate

In a similar manner as was described with reference to FIG. 25, in embodiments, the ladder 16 may be configured with a bottom end gate.

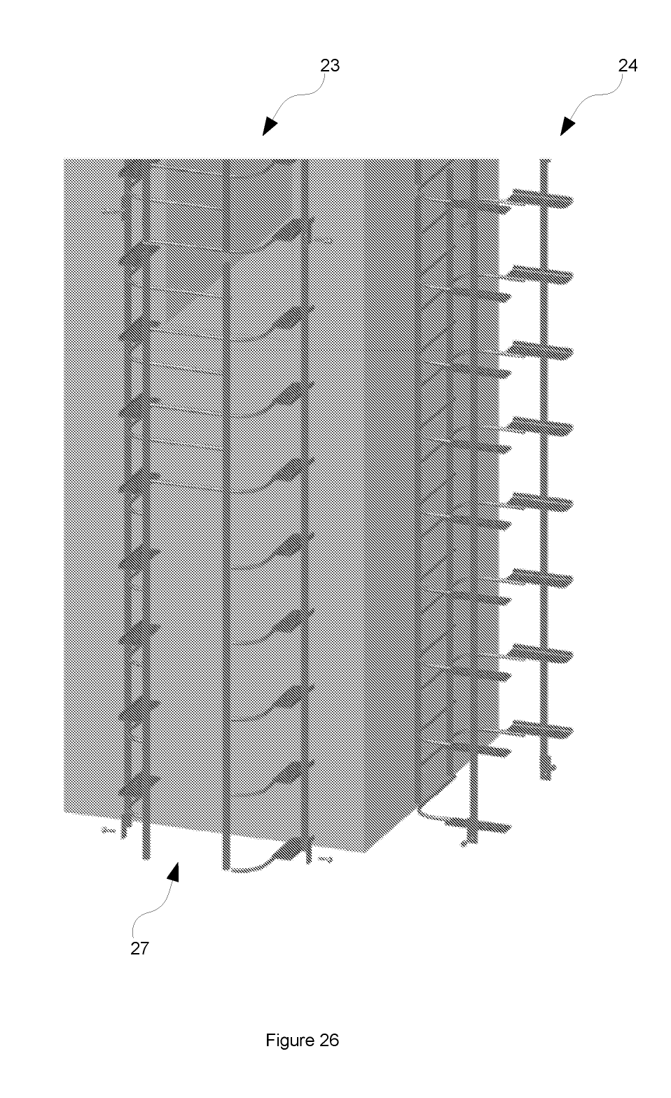

Specifically, FIG. 26 show such an embodiment wherein, as can be seen, in one manner the ladder 16 may be arranged in the rearward facing configuration 27 such that the climber faces away from the building.

In this embodiment, and so as to allow the climber to enter the climbing passage between the steps 14, the central portions of the bottom hand rungs 14 have been removed so as to create a bottom gate 27.

In an alternative embodiment wherein the ladder 25 has been provided in the forward facing configuration 24, the rungs 11 need not be modified as the climber may simply step onto the ladder 16.

As can be appreciated, for the forward facing configuration 24, an upper gate need only be required. Conversely, for the rearward facing configuration 27, a lower gate 27 would only be required.

It should be noted that in embodiment, such as for application within wind generators and the like the ladder 26 may be twist about the central axis so as to transition between rotationally offset entrance and exits of the ladder without requiring a bottom gate 27 or upper gate 22.

### Interpretation

### Embodiments

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the above description of example embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description of Specific Embodiments are hereby expressly incorporated into this Detailed Description of Specific Embodiments, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those in the art. For example, in the following claims, any of the claimed embodiments can be used in any combination.

### Different Instances of Objects

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### Specific Details

In the description provided herein, numerous specific details are set forth. However, it is understood that embodiments of the invention may be practiced without these specific details. In other instances, well-known methods, structures and techniques have not been shown in detail in order not to obscure an understanding of this description.

### Terminology

In describing the preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar technical purpose. Terms such as “forward”, “rearward”, “radially”, “peripherally”, “upwardly”, “downwardly”, and the like are used as words of convenience to provide reference points and are not to be construed as limiting terms.

### Comprising and Including

In the claims which follow and in the preceding description of the invention, except where the context requires otherwise due to express language or necessary implication, the word “comprise” or variations such as “comprises” or “comprising” are used in an inclusive sense, i.e. to specify the presence of the stated features but not to preclude the presence or addition of further features in various embodiments of the invention.

Any one of the terms: including or which includes or that includes as used herein is also an open term that also means including at least the elements/features that follow the term, but not excluding others. Thus, including is synonymous with and means comprising.

### Scope of Invention

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

Although the invention has been described with reference to specific examples, it will be appreciated by those skilled in the art that the invention may be embodied in many other forms.

### INDUSTRIAL APPLICABILITY

It is apparent from the above, that the arrangements described are applicable to the ladder industries.

1. A vertically orientated ladder apparatus comprising:
a pair of laterally positioned and vertically orientated stiles;
opposing horizontal steps immovably fixed to respective inner faces of the lateral stiles for stepping on by a climber in use; and
substantially horizontal hand rungs extending between the stiles for gripping by the climber in use;
wherein the apparatus is configured for allowing a climber to adopt an improved climbing stance in use in that:
the steps project inwardly such that each step is laterally useable for stepping on and off by the climber using lateral step movements of each respective foot of the climber as the climber climbs the ladder;
the steps are spaced apart laterally so as to define a vertical climbing passage therebetween, the climbing passage being sufficiently wide to as to fit at least the shoulders of the climber between the opposing steps to allow a climber to climb within the vertical climbing passage without obstruction by the steps;
the hand rungs are located at an appropriate distance in front of the climber so as to allow sufficient room in front of the climber for the movement of the climber's arms within the lateral extent of the climbing passage as the climber climbs the passage, such that, in the improved climbing stance:
the climber's arms are poised ergonomically in front of the climber within the climbing passage within the room allowed for by the forwardly located hand rungs so as to negate the need for the climber to lean backwards or forwards to grip the hand rungs and wherein the climber is able to reach the hand rungs in front with bent arms while being able to reach the next upper or lower hand rungs with straighter arms;
the climber's legs are spread for the lateral stability of the climber so as to reduce the tendency of the climber falling sideways; and
the climber is substantially upright such that the climber's centre of gravity lies substantially between the opposing steps so as to allow the climber to release the climber's grip on the hand rails while remaining balanced and supported by the legs of the climber and wherein the opposing horizontal steps are alternately vertically staggered.

2. A vertically orientated ladder as claimed in claim 1, wherein each step comprises an outer located vertical end flange to limit the lateral movement of each respective foot in use.

3. A vertically orientated ladder as claimed in claim 1, wherein each hand rung connects a pair of opposing steps.

4. A vertically orientated ladder as claimed in claim 3, wherein each hand rung transitions through substantially 180° so as to provide a portion of the hand rung located at the appropriate distance in front of the climber.

5. A vertically orientated ladder as claimed in claim 4, wherein each hand rungs is substantially U-shaped.

6. (canceled)

7. A vertically orientated ladder as claimed in claim 1, wherein the apparatus further comprises at least one central stile.

8. A vertically orientated ladder as claimed in claim 7, wherein each hand rung is fastened to a respective step and the stile.

9. A vertically orientated ladder as claimed in claim 7, wherein the hand rungs each transition through substantially 90° so as to be able to fasten to the respective step and the stile.

10. A vertically orientated ladder as claimed in claim 9, wherein each hand rung is substantially L-shaped.

11. A vertically orientated ladder as claimed in claim 1, wherein the at least one central stile comprises two central stiles.

12. A vertically orientated ladder as claimed in claim 11, wherein each hand rung is fastened to a respective step and both of the central stiles.

13. A vertically orientated ladder as claimed in claim 1, wherein at least one distal end of each of the pair of laterally positioned stiles comprises connectors for connecting to an adjacent pair of stiles.

14. A vertically orientated ladder as claimed in claim 13, wherein the connectors are fastened to respective surfaces of the respective adjacent stiles so as to allow the adjacent styles to abut directly and in line with each other so as to maintain the weight-bearing capabilities of the adjacent stiles.

15. A vertically orientated ladder as claimed in claim 1, wherein central portions of a subset of the hand rungs are been removed so as to define a climber gate.

16. A vertically orientated ladder as claimed in claim 15, wherein, wherein the ladder apparatus is configured in a forward facing configurations such that the climber faces a building structure, the gate is located at an upper location of the ladder apparatus so as to allow the climber to step onto a raised platform of the building structure through the gate.

17. A vertically orientated ladder as claimed in claim 15, wherein, when the ladder apparatus is configured in a rearward facing configurations such that the climber faces away from a building structure, the gated is located at a ground level of the ladder apparatus so as to allow the climber to step into the climbing passage.
